(19) United States
(12) Patent Application Publication
(10) Pub. No.: US 2010/0319015 A1
(43) Pub. Date: Dec. 16, 2010

(54) METHOD AND SYSTEM FOR REMOVING ADVERTISING CONTENT FROM TELEVISION OR RADIO CONTENT

(76) Inventor: RICHARD ANTHONY REMINGTON, Cave Junction, OR (US)

Correspondence Address: JERRY HAYNES LAW, 2 N OAKDALE AVENUE, MEDFORD, OR, 97501, US

(21) Appl. No.: 12/816,320

(22) Filed: Jun. 15, 2010

Related U.S. Application Data
(60) Provisional application No. 61/187,265, filed on Jun. 15, 2009.

(51) Int. Cl. H04H 60/32

(52) U.S. Cl. 725/19

(57) ABSTRACT

A method and an automated system of identifying and editing commercials are provided. The audio signals of broadcasted television or audio content is received and processed to generate voice print profiles of the actors of a particular show. The voice print profiles are stored in a system database and are periodically updated. The current voice print profile is matched with a previously identified voice print profile to identify commercials. The commercials are edited and the user views the television content without the undesired content.

### CROSS-REFERENCE TO RELATED APPLICATIONS

This application claims the benefit of and incorporates by reference in its entirety U.S. provisional application No. 61/187,265, filed Oct. 1, 2009 and entitled “COMMERICAL IDENTIFICATION SYSTEM”.

### FIELD OF THE INVENTION

The present invention relates to the field of editing advertising content or “commercials”, in general and relates to identifying and editing advertising content from broadcasted television content or radio content based on the voice print profile of the actors, in particular.

### BACKGROUND OF THE INVENTION

Recording television content and then replaying it at the choice of the users is commonly known. Generally, the television content is recorded on a medium such as DVDs, CD's, cassettes, and other storage devices and later played by the user at a convenient time. At all such times, the television content is recorded in whole, along with the commercials. Several recording systems require the user to manually stop and restart the recording of the television content in order to avoid the recording of undesired portions such as the advertising content. All such systems require, however, the user to be alert to the television content and carefully start and stop the recording at the appropriate times. Thus, in such cases, the user often misses the start of some of the commercials thus recording at least a portion of the initial portion of some commercials, and also frequently misses the end of some of the commercials thus skipping the recording of at least a portion of the desirable video content after the commercial ends.

Several automated recording systems are available in the market. These systems monitor commercials based on the audio and video signals of the television content. A drop of the video signal to a black level and the audio signal to a zero level indicates the beginning and end of the commercials. This would result, however, in missing the relevant television content which is dark or muted. Thus, there is a need of an automated system and method of removing undesired content from the television or radio content where the system identifies commercials based on a voice print profile, and removes them.

An objective of the present invention is to provide an automated system to edit advertising content such as commercials based on the voice print profiles of the actors of the television or radio content.

An objective of the present invention is to identify commercials of the television or radio content by matching the current voice print profiles of actors with the previously identified voice print profiles of actors of the television or radio content.

A further objective of the present invention is to skip commercials from television content in “real time” by pressing a button to skip the commercial and then to have the television content automatically resume when the commercial is over.

A further object of the present invention is to remove commercials from pre-recorded shows from the television content so that the end product is completely commercial free with no need to fast forward through the commercials.

Another objective of the present invention is to provide comfort to the user and enabling him to watch television content without commercials.

A further objective of the present invention is to enable the user to skip the advertising content and avoid viewing the television content with commercials and while waiting for the television content to return the user is free to surf the interne, listen to music, or correspond by email.

A further objective of the present invention is to enable the user to view desired content like news, trading tips, and other messages instead of undesired content while watching the television content.

Another objective of the present invention is to allow the user to utilize his time efficiently while watching television content.

An objective of the present invention is to allow user to automatically shift from a first desired channel to a second desired channel and resume the first desired channel for the duration of the commercials on the first desired channel.

### SUMMARY OF THE INVENTION

Embodiments of the present invention provide an automated system and method of removing commercials from television or radio content. Broadcast television or radio content is received from a broadcast channel via a signal comprising an audio data stream. The audio data stream is processed by identifying the average speed and audio theme characteristics of the audio data stream, to generate a voice print profile of the television or radio content. The voice print profile is stored in a system database. The current voice print profile is compared with previously stored voice print profiles to identify commercials. The matched voice print profiles are removed as commercials.

In a preferred embodiment, a method for removing advertising content from television or radio content is provided. The method includes receiving a signal, the signal having an audio data stream of radio or television content; processing the audio data stream to generate a voice print profile of the radio or television content; storing the voice print profile into a system data base, the data base containing previously identified voice print profiles; editing the radio or television content based on matching the voice print profile with respect to the previously identified voice print profiles stored in the system data base; and removing advertising content that matches previously identified advertising content voice print profiles.

In another preferred embodiment, an audio signature based automated system for removing advertising content from television content is provided. The system includes a means for receiving a signal containing an audio signature data stream of television content; a processing unit for processing the audio data stream to generate a voice print profile of the television content, the processing unit further comprises a means for isolating commonly used frequency bands in the audio data stream, means for identifying the average speed of the audio data stream, means for identifying audio theme characteristics in the audio data stream; memory means for storing the voice print profile into a system database containing previously identified voice print profiles; and a control circuit for editing the television content based on matching the voice print profile with respect to the previously identified voice print profile stored in the system database.

In another preferred embodiment, a method for removing advertising content from television content contained in a broadcast signal is provided. The method includes receiving a broadcast signal containing an audio sample data stream; buffering the audio sample data stream; processing the buffered audio sample data stream to generate a voice print profile of the television content, the processing step further comprises, isolating commonly used frequency bands in the audio sample data stream; identifying average speed of the audio sample data stream; and identifying audio theme characteristics in the audio sample data stream; storing the voice print profiles in a system database; providing a control circuit for editing the television content based on matching the voice print profile with respect to the previously identified voice print profiles stored in the system data base; and removing content that matches previously identified voice print profiles.

### BRIEF DESCRIPTION OF THE DRAWINGS

The present invention is illustrated by way of example and not by way of limitation in the figures of the accompanying drawings, in which like references indicated similar elements and in which:

FIG. 1 is a block diagram illustrating the environment in which the current invention would be practiced, in accordance with an embodiment of the present invention.

FIG. 2 is a block diagram illustrating a method of identifying the audio characteristics of actors of the television content, in accordance with an embodiment of the present invention.

FIG. 3 is a flow chart depicting a method of identifying and removing commercials based on voice print profiles of actors, in accordance with an embodiment of the present invention.

FIG. 4 is a flow chart depicting a method of converting analog signals of television content to data streams, in accordance with an embodiment of the present invention.

FIG. 5 is a flow chart depicting a method of identifying, isolating and storing voice print profiles of actors in a system database, in accordance with an embodiment of the present invention.

FIG. 6 is a diagram illustrating the voice print profile collection.

FIG. 7 is a flow chart illustrating updating of audio characterization in the system database based on temporal criteria to determine location of commercials interspersed between the television content, in accordance with an embodiment of the present invention.

FIG. 8 is a flow chart depicting a method of identifying commercials based on the audio characterization, in accordance with an embodiment of the present invention.

FIG. 9 is a flow chart depicting a method of skipping and removing commercials from the television content, in accordance with an embodiment of the present invention.

FIG. 10 is a block diagram illustrating processing audio data stream on multiple broadcast channels, in accordance with an embodiment of the present invention.

FIG. 11 is a block diagram illustrating processing audio data stream simultaneously on a plurality of audio video systems, in accordance with an embodiment of the present invention.

FIG. 12 is a block diagram illustrating processing audio data stream simultaneously on a plurality of audio video systems through a central service provider, in accordance with an embodiment of the present invention.

FIG. 13 is a block diagram depicting a method of making a request to the central service for commercial identification, in accordance with an embodiment of the present invention.

FIG. 14 is a block diagram illustrating an audio signature based automated system for removing advertising content from television content, in accordance with an embodiment of the present invention.

### DETAILED DESCRIPTION OF THE DRAWINGS

Embodiments of the present invention provide a system and a method for editing commercials. The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to practice the disclosure and are not intended to limit the scope of the claims. Furthermore, there is no intention to be bound by any expressed or implied theory presented in the preceding technical field, background, brief summary or the following detailed description.

Throughout the description, the terms “advertising content” and “commercials” are used interchangeably and the term “radio content” and can be used interchangeably throughout for the term “television content”. Those skilled in the art will appreciate that the present invention can utilize television and radio content in any language and in any country of the world.

An automated system and method of removing commercials from television content is provided. Television content is received from a broadcast channel via a signal comprising an audio data stream. The audio data stream is processed by identifying the average speed and audio theme characteristics of the audio data stream, to generate a voice print profile of the television content. The voice print profile is stored in a system database. The current voice print profile is compared with previously stored voice print profiles to identify commercials. The matched voice print profiles are removed as commercials.

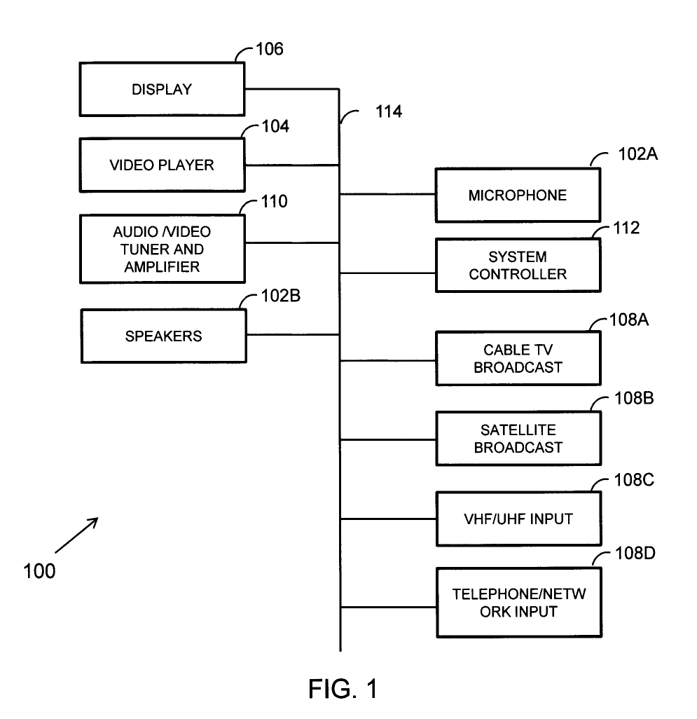

Referring now to the drawings, FIG. 1 is a block diagram illustrating the audio-video system 100 in which the current invention would be practiced, in accordance with an embodiment of the present invention. Audio-video system 100 includes an audio input-output device 102, a video player 104, a video output device 106, video service provider 108 and an audio-video tuner-amplifier 110. Audio input-output device 102 receives and emits the audio signals from a video of the television content broadcasted on a channel. In an embodiment of the present invention, the audio input-output device includes a microphone 102A. In another embodiment of the present invention, the audio input-output device includes speakers 102B.

Video player 104 is a device that provides the video content to the user. Examples of video player include, but are not limited to VCR, laserdisc player, CD players, and DVD players. In an embodiment of the present invention, the television content is recorded on a medium (CD, DVD, etc.) through video players and then provided to the user. In another embodiment of the present invention, the recorded television content available on a medium is played by a video player and provided to the user. The video played by the video players are displayed to the user on video output device 106. In an embodiment of the present invention, the video output device includes a screen/monitor. Video service provider 108 is a service provider that makes television content available to a user through a broadcast. Examples of service providers include, but are not limited to, Cable TV broadcast 108A, satellite broadcast 108B, VHF/UHF Input 108C, and telephone/Network input 108D. Audio-video tuner-amplifier 110 is an audio-video signal receiver. The audio-video tuner amplifier amplifies sound from a multitude of possible audio sources as well as route video signals to video output device 106 from various sources.

In an embodiment of the present invention, audio video system 100 includes a system controller 112. System controller 112 includes a microprocessor for audio and/or video processing, video storage, audio storage, and/or data storage for the system. In an embodiment of the present invention, the system controller 112 operates to receive broadcast data available from a plurality of video service providers and analyze the television content to determine which portion of the television content contains commercials and which portions of the television content do not contain commercials.

The various components of the audio-video system may work in a coherent manner or an independent manner. In an embodiment of the present invention, the audio-video system works on a communication channel 114. The communication channel includes one or more separate data paths to interconnect various components of the audio-video system, together in any suitable manner. In an embodiment of the present invention, the communication channel may be on circuit boards, cables, wires, infrared signals, radio frequency signals, or any other data communication mechanism.

For purposes of this application, the undesirable television content is analogous to commercial content. The television content broadcasted by video service providers comprise audio and video signals. The desirable television content was differentiated from commercial content based on the audio signals in general, and audio characteristics of the television content in particular. In an embodiment of the present invention, audio characteristics include, but are not limited to, the voice of actors of a particular show, theme songs, audio queues, and background score.

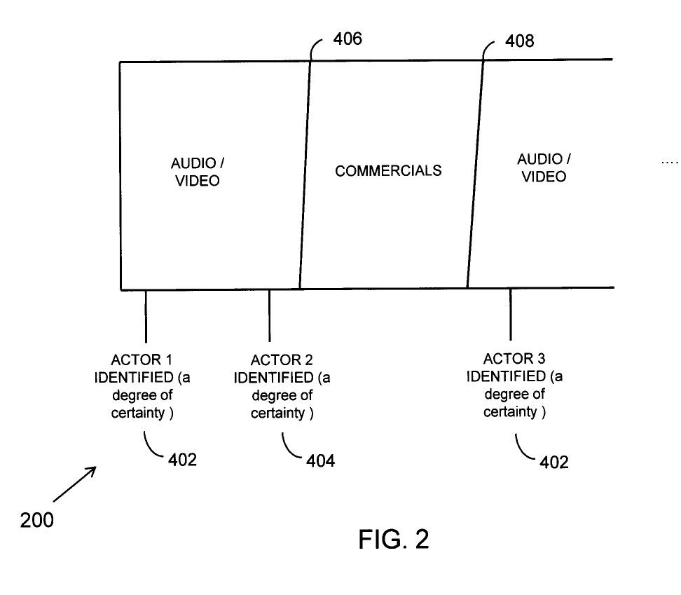

Referring now to FIG. 2, block diagram 200 illustrates a method of identifying the audio characteristics of actors of the television content, in accordance with an embodiment of the present invention. The audio-video system receives audio-video signals comprising an audiovisual data stream through the audio input device and video input device. The audio signals are processed to identify the audio characteristics of the various actors of a particular show. In an embodiment of the present invention, first actor 402 is identified based on its audio characteristics. The audio signals are further processed to identify the audio characteristics of second actor 404. In an embodiment of the present invention, the first actor and the second actor may be same or different. In an embodiment of the present invention, the various actors of the broadcasted television content are identified in a similar manner.

In an embodiment of the present invention, the audio characteristics of various actors are analyzed to determine that the audio characteristics of the actors of the program are different than the audio characteristics of the actors of the commercial content. This helps in identifying and determining the start 406 and the end 408 of the commercial content.

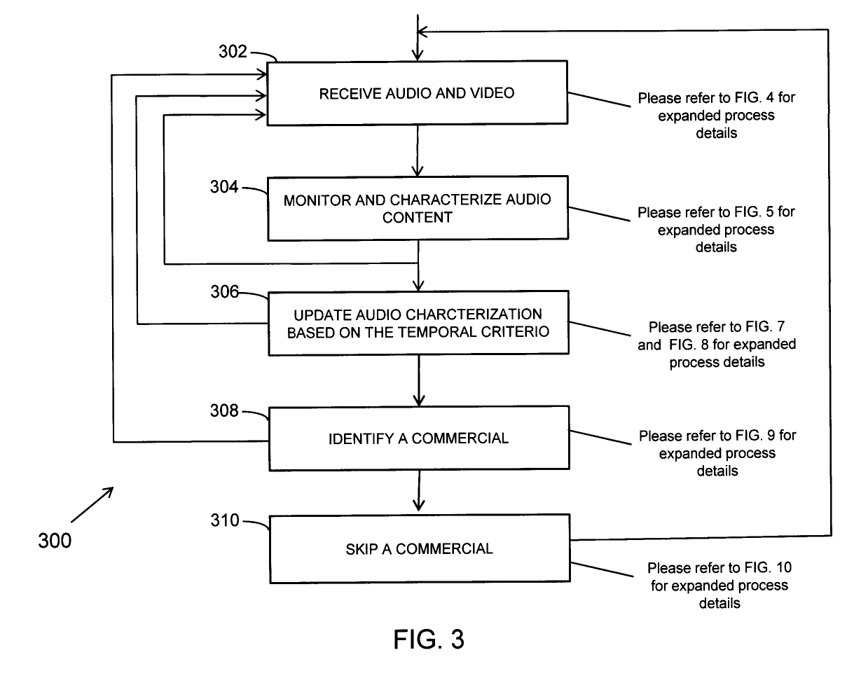

Referring now to FIG. 3, flow diagram 300 depicts a method of identifying and removing commercials based on audio characteristics of actors, in accordance with an embodiment of the present invention. At step 302, the audio-video signals comprising an audiovisual data stream are received by the audio input device and video input device.

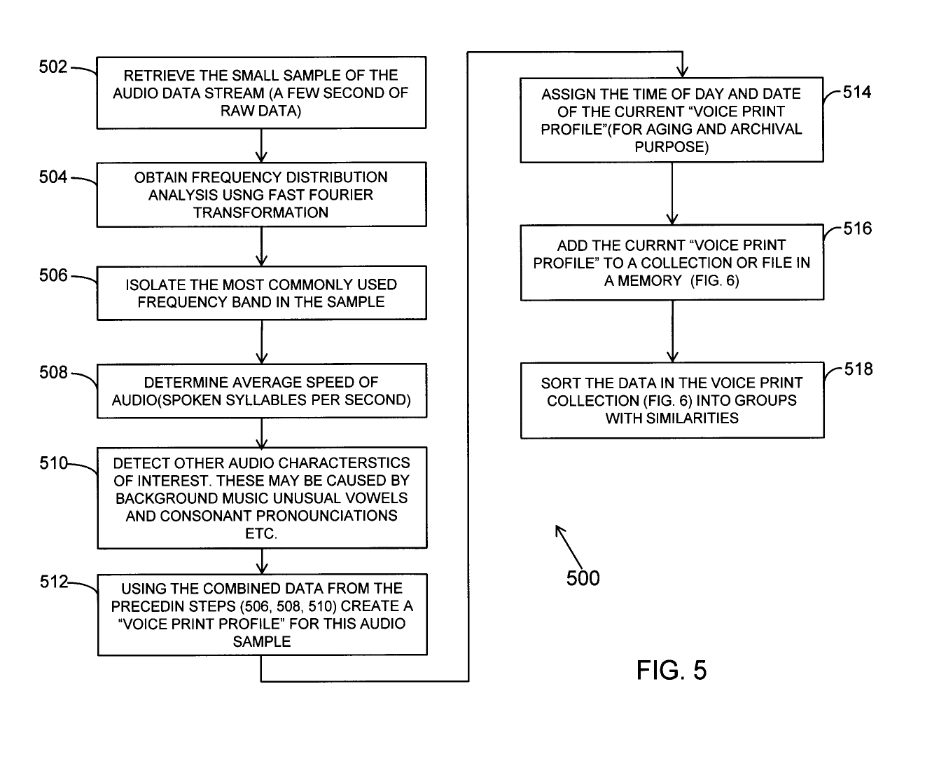

The audio signals of audiovisual data stream are monitored and characterised by the system controller at step 304. The audio signals are identified and classified based on the audio characteristics of the television content. In an embodiment of the present invention, audio characteristics include, but are not limited to, voice of actors of a particular show, theme songs, audio queues, and background score. System controller 112 compares the audio characteristics and determines that one section of the audio is different than another portion of the audio. This is based on that the audio characteristics of actors of desirable television content are different than the audio characteristics of the commercial content. This helps determine that the audio characteristics are of the commercial content and not of the desirable television content. The start 406 and end 408 of the commercial is identified. In an embodiment of the present invention, the anticipated duration of the commercial may also be taken into consideration. The television content is continually processed to identify commercials. Details corresponding to audio characterization of the television content have been provided in conjunction with FIG. 5.

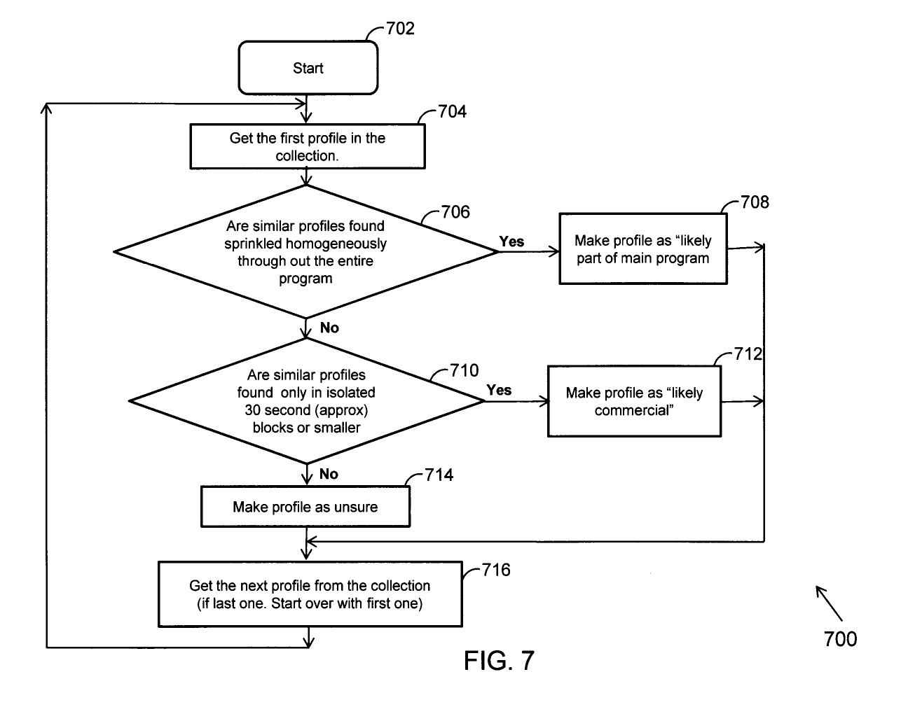

At step 306, the audio characteristics stored in the system database are updated. The television content is continually processed to identify and classify audio characteristics. The classified characteristics updated in the system database. Details of how the audio characteristics are identified and classified have been provided in conjunction with FIG. 7.

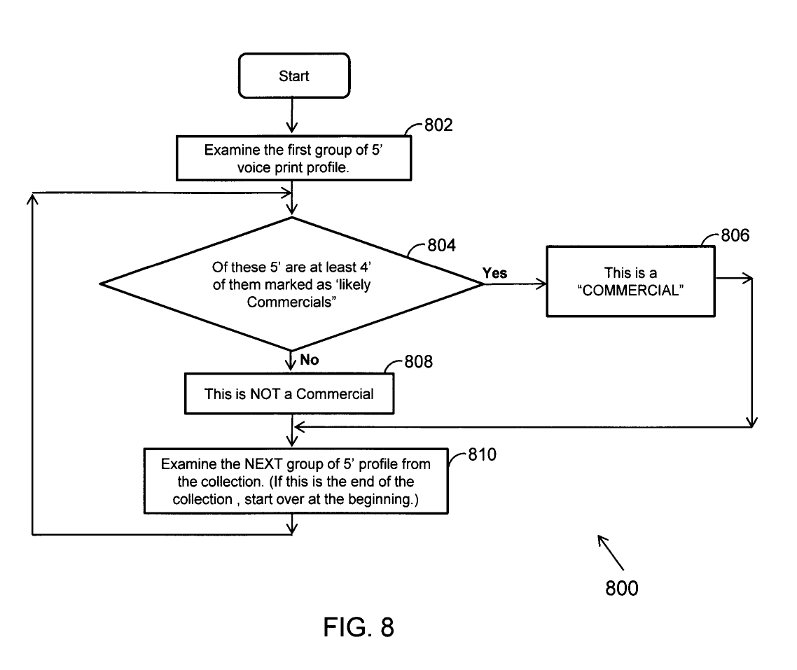

The audio characteristics are processed and analysed to identify the commercial at step 308. Details of how the commercial content is identified have been provided in conjunction with FIG. 8.

At step 310, the commercial content is skipped and eliminated while viewing the television content. In an embodiment of the present invention, the commercial content is identified and eliminated while recording the television content. In another embodiment of the present invention, the commercial content is identified and skipped in real time.

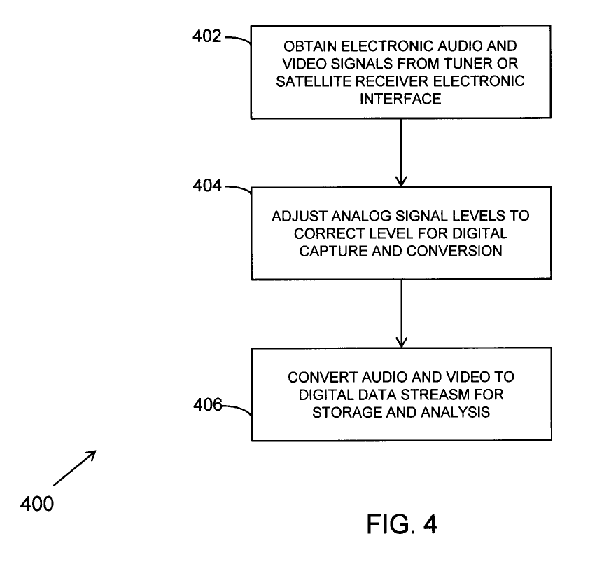

Referring now to FIG. 4, flow diagram 400 depicts a method of converting analog signals of television content into data streams, in accordance with an embodiment of the present invention. At step 402, electronic audio-video signals corresponding to the television content are received. In an embodiment of the present invention, the signals are received through a tuner. In another embodiment of the present invention, the signals are received through a satellite receiver electronic interface.

The audio and video signal levels are adjusted to levels suitable for digital capture and conversion at step 404.

At step 406, the audio and video signals are converted to audio data streams and video data streams. In an embodiment of the present invention, the data streams are stored for further processing and analysis.

Referring now to FIG. 5, flow diagram 500 depicts a method of identifying, isolating, and storing voice print profiles of actors in a system database, in accordance with an embodiment of the present invention. At step 502, a small sample of the audio data stream stored is retrieved. In an embodiment of the present invention, the sample corresponds to a few seconds of raw data. In an embodiment of the present invention, the sample is delineated at points of relative quietness, such as natural pauses in speech or gaps between the beats. In an embodiment of the present invention, the volume level of the sample is normalized.

At step 504, the sample of the audio data stream is analyzed employing “Fast Fourier Transformation”. A fast Fourier transform (FFT) is an efficient algorithm to compute the discrete Fourier transform (DFT) and it's inverse. In an embodiment of the present invention, the FFT creates a spectrum frequency distribution analysis or spectrogram of the sample.

At step 506, frequency bands are isolated based on the spectrogram of the sample of the audio data stream. The spectrogram of the sample analyzed, is processed and simplified into a list of the most commonly used frequency bands. In an embodiment of the present invention, the simplification of data aids in reducing the computer memory needs and calculation speed requirements to work with the sample data.

The average speed of the sample of the audio data stream is determined at step 508. In an embodiment of the present invention, the average speed is determined by dividing the syllable or beat count by the length of the audio sample.

At step 510, the audio sample is further analyzed to identify unusual audio characteristics. In an embodiment of the present invention, unusual audio characteristics include, but are not limited to, background score, consonant and vowel pronunciation etc.

At step 512, the most commonly used frequency bands identified at step 506, the average speed of the sample determined at step 508, and the unusual characteristics identified at step 510, are consolidated and compiled to form a “Voice Print Profile”. Voice print profile is the voice footprint of an individual. In an embodiment of the present invention, the voice print profile helps in differentiating the voice of one individual from another.

At step 514, the voice print profile is stored in computer memory along with a corresponding time and date stamp. In an embodiment of the present invention, the time and date stamp allows the data to be aged and archived as appropriate and aid in determining if the data is likely to belong to a commercial.

The voice print profile with a time and date stamp is stored in a system database at step 516. The stored information can be retrieved at any time.

At step 518, the voice print profiles stored are indexed, sorted and grouped based on the characteristics realized at steps 506, 508 an 510. In an embodiment of the present invention, the sorted and grouped voice print profiles can help gain speed of the system when comparing new/current voice print profile as it arrives with previously identified voice print profile.

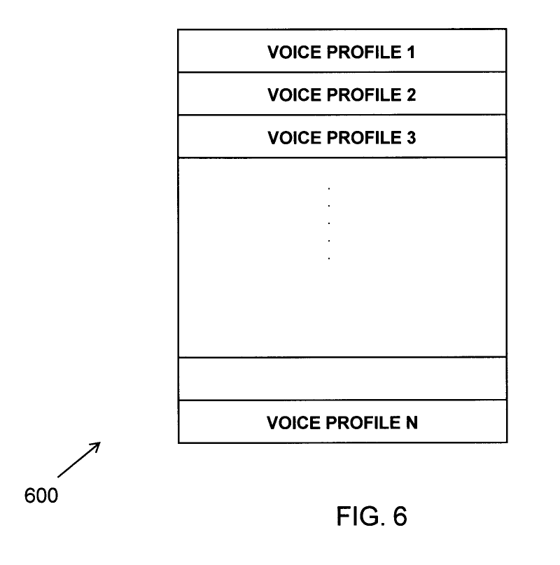

Referring now to FIG. 6, block diagram 600 illustrates the voice print profile collection. Each voice print profile consists of a very compact but descriptive analysis of the corresponding segment of audio sample. This compact analysis tells which audio frequencies were predominantly used in the segment of audio, how rapidly syllables were spoken (or the tempo in the case of music) and other unique characteristics. The compact analysis will also function similar to a computer data hash in that two identical profiles indicate a high likelihood that the entire audio segments are also identical. The profile also contains a time and date stamp indicating when the sampling occurred. The voice print profiles of the sample are determined based on the most commonly used frequency bands, average speed of the sample and unusual audio characteristics. These voice print profiles are stamped with time and date and stored on a system database. The stored voice print profiles are indexed, sorted, and grouped based on the characteristics. In an embodiment of the present invention, voice print profile 1, voice print profile 2, and voice print profile 3 correspond to one group of voice print profiles.

Referring now to FIG. 7, flow diagram 700 illustrates updating of audio characterization in the system database based on temporal criteria to determine location of commercials interspersed between the television content, in accordance with an embodiment of the present invention. At step 702, the user makes a choice to start content by pressing a “skip commercial” button. In an embodiment of the present invention, the “skip commercial” button is provided on a remote control.

At step 704, a first voice print profile is selected from the collection of stored voice print profiles. At step 706, a search is performed to look for similar profiles in the collection. A similar profile indicates a high probability that an actor's identity is the same in both instances. Further, the time stamps of the search results are examined to determine if the profile is likely to be part of the main program.

If the time stamps show a homogenous sampling across the entire program then the current profile is marked as “Part of the Main Program” at step 708. Otherwise, a search is performed to look for matching profiles in isolated time blocks of approximately 30 seconds at step 710. The profiles are considered isolated if they occur at intervals. If the profiles match then they are marked as “Part of a Commercial” at step 712. In an embodiment of the present invention, if the profiles fail to get categorized as part of the program or as a commercial then the profile will be marked as “Unsure” at step 714.

At step 716, the system controller gets the next voice print profile to be characterized. If this was the last profile in the collection then it goes back to the first profile in the list and starts the analysis anew at step 704. This is a continuous process that improves its accuracy as more data becomes available. Accordingly, it runs in the background contemporaneously.

Referring now to FIG. 8, flow diagram 800 depicts a method of further processing and identifying commercials based on the audio characterization, in accordance with an embodiment of the present invention. At step 802, a sequential group of voice print profiles are examined by the software. A sample group of three or more can be used. Those skilled in the art will appreciate that sample size can vary greatly with larger sample sizes in general providing greater accuracy. For purposes of illustration only, a sample group of 5 voice print profiles that have been categorized is examined.

The profiles are matched internally and analyzed at step 804. If for example 4 out of 5 voice print profiles have been marked as likely advertising content, then the sample is marked as “Commercial” at step 806. Otherwise, the sample is marked as “Not a Commercial” at step 808.

At step 810, the next 5 voice print profiles are examined and marked accordingly.

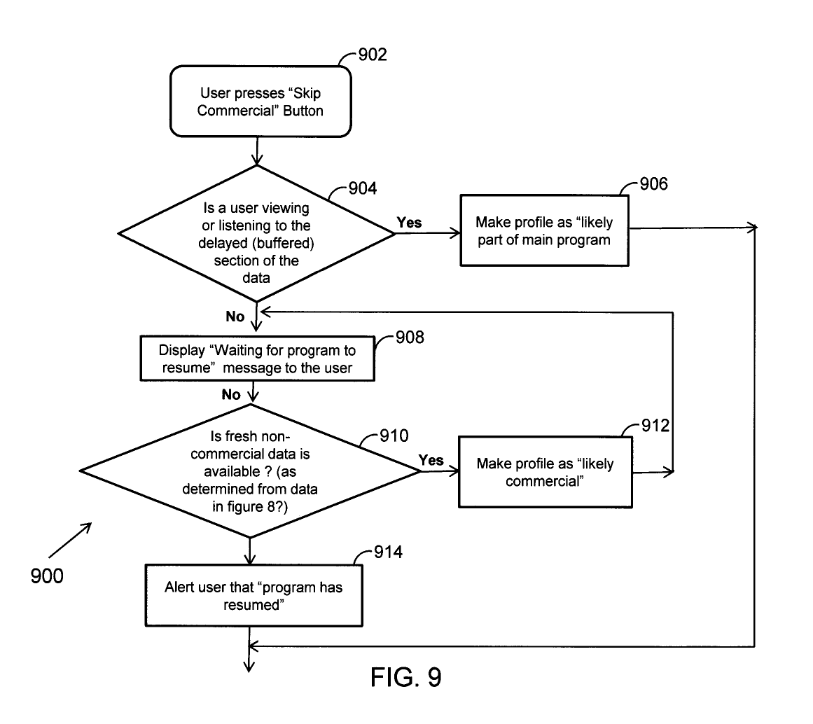

Referring now to FIG. 9, flow diagram 900 depicts a method of skipping and removing commercials from the television content, in accordance with an embodiment of the present invention. At step 902, the user makes a choice to edit and skip commercials from the television content by pressing a “skip commercial” button. In an embodiment of the present invention, the “skip commercial” button is provided on a remote control.

The broadcast viewed by the user is determined as delayed or buffered data at step 904.

In case the user is viewing delayed or buffered data, then the playback position will be advanced to the end of the commercial mainly into while watching the recorded data (as determined from data that was produced in FIG. 8) at step 906.

In case the user is listening to, or viewing live, (unbuffered) data, it is not possible to immediately skip the commercial. In this case the user is presented with a message at step 908 indicating that the system is waiting for the program to resume. The system will continue to monitor for the resumption of the program. During this time, the audio volume will be reduced or muted.

The data are continuously examined at step 910 and categorized at step 912.

When the system detects that the program has resumed the user will receive a message or audio alert that his program is ready to resume at step 914. This condition signifies that newer voice print profiles have been marked as definitely part of the program, not part of a commercial. Depending on user preferences the program will resume automatically or wait for the user to indicate he is ready for the program to resume. In this manner, a smoother transition from the video content to the commercial content back to the video content, without missing much of the video content or including much of the commercial content, is more likely to be achieved.

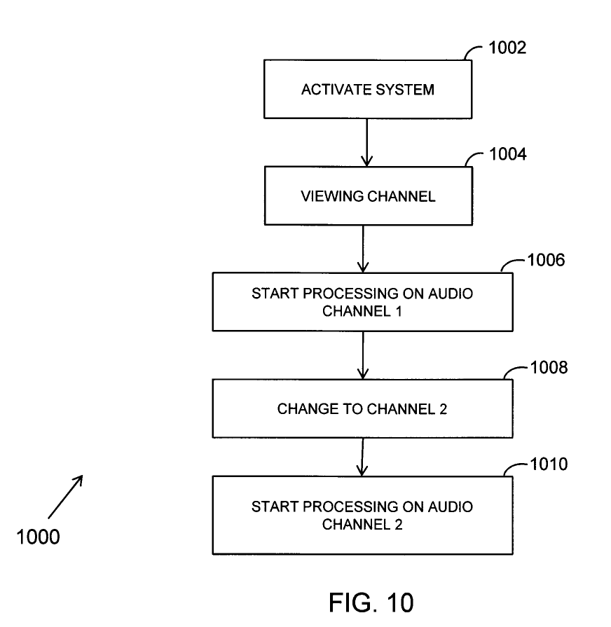

Referring now to FIG. 10, flow diagram 1000 depicts a method of skipping and removing commercials from the television content, in accordance with an embodiment of the present invention. At step 1002, the audio-video system is activated.

In an embodiment of the present invention, the audio-video system is switched on to view a first broadcast channel of choice at step 1004. The user at times may desire to select a second broadcast channel.

When the user changes to a second broadcast channel, system controller 112 buffers and processes the data stream from the first broadcast channel for a few seconds at step 1006.

In an embodiment of the present invention, the data stream from the first broadcast channel is buffered to identify commercials based on the initial audio information and audio characteristics of actors. Accordingly, the system controller may automatically buffer the second broadcast channel when the channel is selected, depicted in Step 1008.

Processing of channel 2 audio is commenced in Step 1010. In an embodiment of the present invention, additional buffering of data stream may occur when the user switches channels. This buffering enables uninterrupted viewing experience upon switching to the other channel. In another embodiment of the present invention, the broadcasted channel is presented to the user for limited time duration before the buffering occurs. This enables the user to surf through a number of different channels before the buffering occurs.

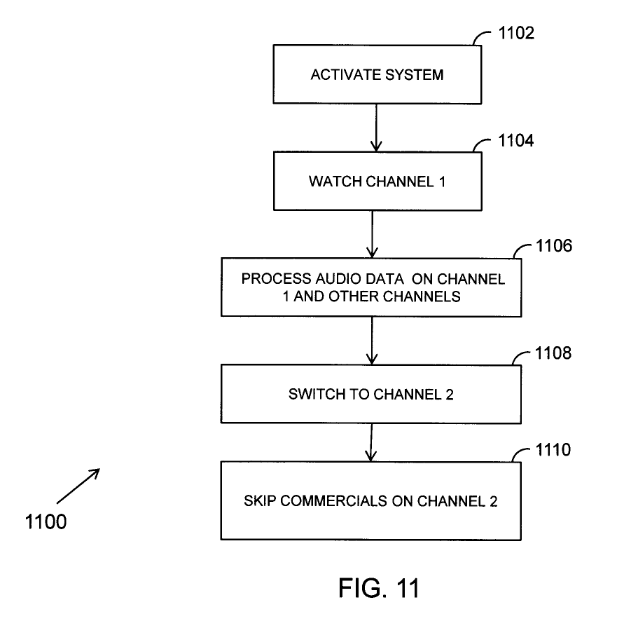

Referring now to FIG. 11, flow diagram 1100 illustrates processing audio data stream on multiple broadcast channels, in accordance with an embodiment of the present invention. At step 1102, the audio-video system is activated.

In an embodiment of the present invention, the audio-video system is switched on to view a first broadcast channel of choice at step 1104. The user at times may desire to select a second broadcast channel.

At step 1106, the system controller “simultaneously” buffer the data stream for a plurality of broadcast channels and process each of the broadcast channels in a “parallel” fashion to acquire data appropriate for commercial identification on each of the channels.

At step 1108, the user switches to a second broadcast channel. In an embodiment of the present invention, when the user switches channel, the system controller, has some suitable data for commercial identification.

At step 1110, the commercials are skipped based on the buffered data. In an embodiment of the present invention, the television content is presented to the user with an accurate determination before skipping the next commercial.

The voice print profiles based on the processed audio data from a first user watching a particular show may be useful to others viewers of the same content, either at approximately the same time or a later time, so that they may likewise skip the commercial content.

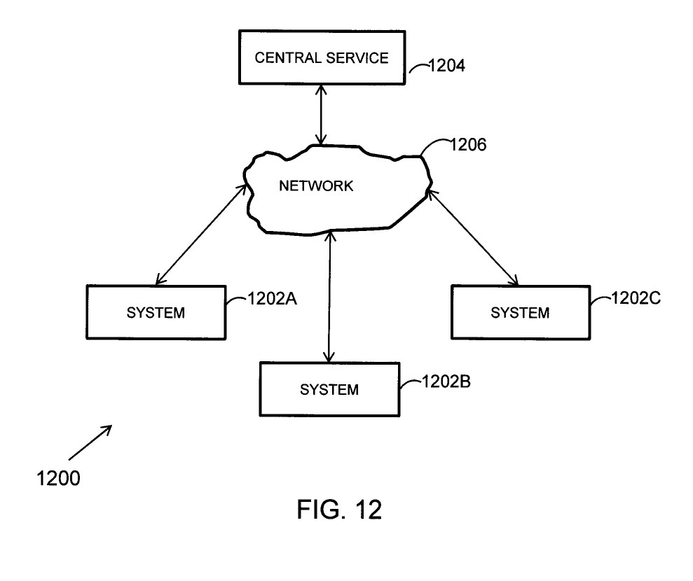

Referring now to FIG. 12, diagram 1200 illustrates processing an audio data stream simultaneously on a plurality of audio video systems through a central service provider, in accordance with another embodiment of the present invention. In an embodiment of the present invention, exchange of information is facilitated through a plurality of systems 1202 that communicate with a central service 1204, over a FTP site/website/networked service 1206. In an embodiment of present invention, audio-video systems, 1202A, 1202B, and 1202C communicate with a central service 1204 through a network 1206. This enables in gathering commercial identification information.

Examples of the commercial identification information include, but are not limited to, the particular show being viewed, the time that the particular show is being watched, the identification of each commercial in the show, and the duration of each commercial in the show, audio information identifying particular actors, and audio information identifying audio queues in the particular show, geographic information of the location of the system.

In an embodiment of the present invention, the central service receives information for a particular show from a plurality of systems. The received information may be processed by the central service to statistically determine a more accurate identification of the commercials within a particular show.

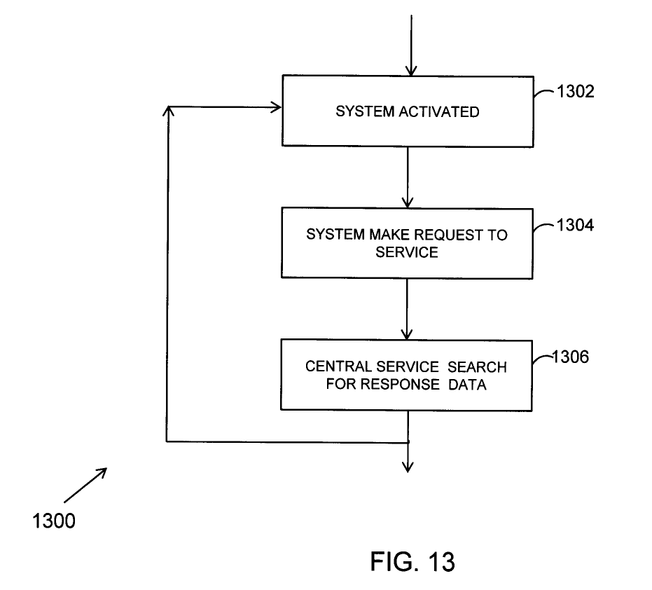

Referring now to FIG. 13, flow diagram 1300 depicts a method of making a request to the central service for commercial identification, in accordance with another embodiment of the present invention. An audio-video system is activated at step 1302.

The system makes a request to the central service of commercial identification information at step 1304. In an embodiment of the present invention, the request may include channel identification information, show identification information and/or geographic information of where the user is located.

At step 1306, the central service searches for corresponding content for the identified channel/content for the particular geographic location. This assists to readily identify the desired content. Accordingly, for content that is broadcast multiple times the server may be able to provide useful commercial identification data for the current broadcast based upon historical broadcasts. The system controller uses this information to identify commercials automatically or otherwise to assist in the identification of commercials to increase the degree of certainty that particular content is a commercial.

In another embodiment of the present invention, the central service may not have commercial identification information for a particular channel for a particular geographic location. The central service may search an electronic program guide or other database that includes information related to what particular show is being shown on the requested particular channel for the relevant geographic location. The data provided to the central service may likewise include program identification information or is otherwise associated by the central service with program identification information, such as program name and description. In this manner, the central service may include program identification associated with the identification of commercials therein (or otherwise the pattern of commercials) for that particular content.

In an embodiment of the present invention, the central service may likewise update its data for a particular show and/or content based on data retrieved from additional sources. In the event that the data for a particular content appears to be inconsistent, such as the commercials tend to vary in location and/or duration significantly, the central service may simply remove the commercial location information in order to reduce the likelihood of providing false data. In this case, the actor and/or characteristic data may still be useful. Further, the central service may likewise download data to the audio video systems on a periodic basis so that the audio video systems have commercial identification data for much of the content that the user may desire to view in the near future. This downloading of data may likewise be based upon the user's viewing history.

In another embodiment of the present invention, the systems may be interconnected in a peer-to-peer fashion, a client-server fashion, or a hybrid of the two.

In an embodiment of the present invention, while the commercial is being skipped in real time, the viewer will have 30 seconds, 60 seconds, or more, to wait until the desired content is continued. During this time a “save and return” button on the remote control may be pressed which switches to another channel temporarily, and returns to the previous channel when the desired content resumes. In this manner, the viewer will not be presented as many commercials. In addition, during the save and return time period, news from the Internet or other content from the Internet may be provided to the viewer. This content from the Internet may be pre-selected, such as a customized web page, of stock prices, local news, national news, sports scores, present text messages that have been received, provide e-mails.

In another embodiment of the present invention, a user may be watching different programs at the same time, such as a first football game and a second football game at the same time. When a commercial occurs the system may automatically switch to the other football game. Further the system may switch back to the first football game when commercials end. This process may be repeated until the content for both football games has been presented. In this manner, the viewer may watch both football games without watching the corresponding commercials. The portions of the football games not currently being presented to the viewer in real-time may be stored on a storage device and presented to the viewer from the storage device when the switching occurs.

In addition to audiovisual content, the commercial identification and skipping system may likewise be applied to multiple radio channels, such as a pair of talk radio shows.

The system controller may be implemented as a stand-alone commercial editing system provided in-line with the audiovisual content being provided to the television. In other cases, the system may be embedded in a television. In this case, some of the processing pipeline of the television may be used. In other cases, a digital video recorder, similar in nature to a Tivo™, may be used to record and process content. In other cases, a general purpose computer may be used. In many cases, it may be desirable to use the network connectivity of a cellular phone to download data to the system and provide uploads of data to the server (or other device). In other cases, it may be desirable to use the network connectivity of the television or internal network connectivity to download data to the system and provide uploads of data to the server (or other device). In some cases, it is desirable for the audiovisual content to be presented on a cellular phone (e.g., handheld device), use the cellular phone for data processing, and use the server to provide information to and receive information from.

In an embodiment of the present invention, system controller/central service may likewise develop a set of characteristics of particular actors. When these actors are anticipated to be present in a particular show (such as information available from an electronic programming guide) then one or more actor characteristics will already be available. This is also suitable for audio characteristics. This library of audio characteristic content reduces the computational demands on the system and server. In another embodiment of the present invention, system controller/central service may likewise develop a set of anticipated commercial patterns for one or more different types of content. The type or content may be available in a database or electronic program guide, on the system, server or otherwise, and therefore provide information to assist in the identification of the commercials.

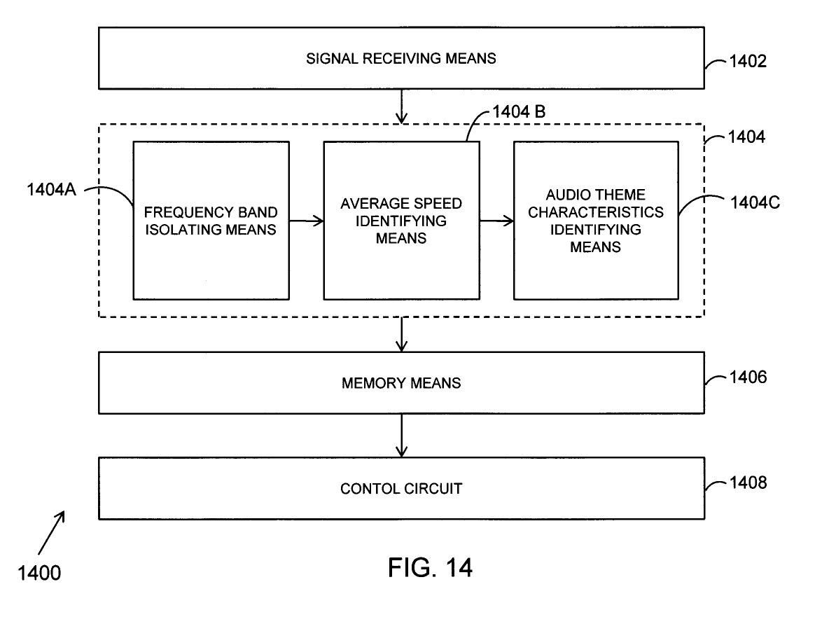

Referring now to FIG. 14, block diagram 1400 illustrates an audio signature based automated system for removing advertising content from television content, in accordance with another embodiment of the present invention. The automated system includes a signal receiving means 1402, a processing unit 1404, a memory means 1406, and a control circuit 1408.

The signal receiving means 1402 receives audio and video signals of television content of a broadcast. In an embodiment of the present invention, signal receiving means include a tuner and an amplifier.

The processing unit 1404 processes the audio signals containing audio data streams to generate voice print profiles of a sample. The processing unit further comprises, frequency band isolating means 1404A, average speed identifying means 1404B, and audio theme characteristics identifying means 1404C. The voice print profile is generated based on the commonly used frequency bands, average speed and unusual audio characteristics of a sample. The voice print profiles are further processed, categorized, sorted and indexed. The indexed voice print profiles are stored on the memory means 1406. The control circuit 1408 of the automated system 1400 matches the voice print profile with existing voice print profiles to identify a commercial and then edit it.

While the illustrative embodiments of the disclosure have been described above, it will be recognized and understood that various modifications can be made in the disclosure and the appended claims are intended to cover all such modifications which may fall within the spirit and scope of the disclosure.

What is claimed is:

1. A method for removing advertising content from broadcast television or radio content, the method comprising the steps of:
a. receiving a signal, the signal comprising an audio data stream of broadcast content;
b. processing the audio data stream to generate a voice print profile of the television or radio content;
c. storing the voice print profile into a system data base, the data base containing previously identified voice print profiles;
d. editing the broadcast content based on matching the voice print profile with respect to the previously identified voice print profiles stored in the system data base; and
e. removing advertising content that matches previously identified advertising content voice print profiles.

2. The method of claim 1 wherein processing the audio data stream step comprises the steps of:
a. isolating commonly used frequency bands in the audio data stream;
b. identifying the average speed of the audio data stream; and
c. identifying audio theme characteristics in the audio data stream.

3. The method of claim 1, wherein the signal is received from a data transmission path selected from cable TV, wireless broadcast, VHF/UHF input, digital subscriber line, satellite broadcast, and digital and analog telephone network transmission.

4. The method of claim 1, wherein the processing of audio data stream comprises capturing distinctive audio characteristics associated with particular television content.

5. The method of claim 1, wherein the voice print profiles are marked with a time and date stamp.

6. The method of claim 1, wherein the voice print profiles are indexed and grouped according to characteristics of the audio data stream.

7. The method of claim 1, wherein the editing step comprises distinguishing advertising content from non-advertising content.

8. The method of claim 7, wherein the editing step comprises matching the current voice print profile with the previously identified voice print profiles to distinguish between advertising content and non-advertising content.

9. The method of claim 7, wherein the editing step comprises stopping and resuming the stream of the television content based on distinguishing advertising content from non-advertising content.

10. The method of claim 1, wherein the editing step comprises stopping the stream of the television content for an interval of time when the advertising content is being broadcast.

11. The method of claim 1, wherein the editing comprises muting or removing the stream of the television content for an interval of time when the advertising content is being broadcast.

12. The method of claim 11 wherein during the interval when the advertising content is muted or removed a user has the option to switch to receiving an alternative content signal and to return to the original signal when non-advertising content resumes.

13. The method of claim 11 wherein the interval of time when the advertising content is muted or removed ranges from about 5 seconds to about 10 minutes.

14. The method of claim 1, wherein the editing step comprises resuming the television content when the non-advertising content is being broadcast.

15. The method of claim 1, wherein the voice print profiles database is periodically updated.

16. An audio signature based automated system for removing advertising content from television content, the system comprising:
a. means for receiving a signal containing an audio signature data stream of television content;
b. a processing unit for processing the audio data stream to generate a voice print profile of the television content, the processing unit further comprises a means for isolating commonly used frequency bands in the audio data stream, means for identifying the average speed of the audio data stream, means for identifying audio theme characteristics in the audio data stream;
c. memory means for storing the voice print profile into a system database containing previously identified voice print profiles; and
d. a control circuit for editing the television content based on matching the voice print profile with respect to the previously identified voice print profile stored in the system database.

17. The system of claim 17, wherein the wherein the signal is received from a data transmission path selected from cable TV, wireless broadcast, VHF/UHF input, digital subscriber line, satellite broadcast, and digital and analog telephone network transmission.

18. The system of claim 17, wherein the control circuit is utilized to distinguish undesired/commercial content from desired/television content.

19. The system of claim 17, wherein the system database of voice print profiles database is periodically updated.

20. A method for removing advertising content from television content contained in a broadcast signal, the method comprising the steps of:
a. receiving a broadcast signal containing an audio sample data stream;
b. buffering the audio sample data stream;
c. processing the buffered audio sample data stream to generate a voice print profile of the television content, the processing step further comprises, isolating commonly used frequency bands in the audio sample data stream; identifying average speed of the audio sample data stream; and identifying audio theme characteristics in the audio sample data stream;
d. storing the voice print profiles in a system database;
e. providing a control circuit for editing the radio content based on matching the voice print profile with respect to the previously identified voice print profiles stored in the system data base; and
f. removing content that matches previously identified voice print profiles.
